(19) United States
(12) Patent Application Publication
(10) Pub. No.: US 2009/0317689 A1
(43) Pub. Date: Dec. 24, 2009

(54) LIQUID SUPPLY CONTAINER AND FUEL CELL SYSTEM WITH THE SAME

(75) Inventors: Hidekazu Kimura, Tokyo (JP); Suguru Watanabe, Tokyo (JP); Toru Takahashi, Kanagawa (JP); Nobuo Katsuura, Kanagawa (JP); Minoru Murata, Tokyo (JP); Kiyoshi Isobe, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Minato-ku, Tokyo (JP)

(21) Appl. No.: 12/374,986

(22) PCT Filed: Jul. 9, 2007
(86) PCT No.: PCT/JP2007/000743

§ 371 Date: Jan. 23, 2009

(30) Foreign Application Priority Data
Jul. 26, 2006 (JP) 2006-202942

(51) Int. Cl. H01M 2/02; B65D 90/36

(52) U.S. Cl. 429/34; 220/89.1

(57) ABSTRACT

A liquid supply container (1) provided in a fuel cell system includes a liquid chamber (10) that stores liquid therein, and a liquid supply port (30) provided in the liquid chamber (10) so as to supply the liquid stored therein to a liquid acceptor, and the liquid chamber (10) includes a groove (11) having a V-shape cross-section and formed on an upper surface (13C) of the liquid chamber (10), which serves to allow communication between the inside and the outside of the liquid chamber (10) in the case the internal pressure increases over a predetermined level.

### TECHNICAL FIELD

The present invention relates to a liquid supply container that accommodates various liquids such as a liquid fuel for use in a fuel cell, and supplies the accommodated liquid to a liquid acceptor, and to a fuel cell system that includes such liquid supply container.

### BACKGROUND ART

Liquid supply containers that accommodate a liquid so as to supply the liquid to a liquid acceptor of various apparatuses have conventionally been widely utilized, for example in those apparatuses that employ a liquid fuel, such as a fuel cell system, or in the case of dosing a medical solution. The liquid supply container itself can be directly replaced when the liquid to be supplied is exhausted, and hence offers the advantage that the user's hand is kept from being stained by the liquid, which provides higher safety, and that the apparatus can be easily refilled with the liquid. This is a very effective means especially when employing a liquid that may affect the human body or is remarkably degraded upon being exposed to ambient atmosphere.

Meanwhile, the fuel cell that employs a liquid as the fuel for generation has recently been progressively developed, and in particular a methanol direct fuel cell (hereinafter, DMFC) which employs methanol as the fuel is being aggressively developed by many electric manufacturers and the like. The DMFC is expected to be a new type, next-generation cell for use in note PCs, various portable electronic apparatuses, mobile phones and so forth. Generally, however, the methanol considerably affects the human body such that, once aspirated, the methanol attacks the central nerve or may cause vertigo, diarrhea and so on.

Moreover, the methanol is a highly dangerous and harmful liquid, as in case a person aspirates a large amount of methanol or the methanol intrudes into his/her eye the person may suffer a lesion in the optic nerve or even lose his/her eyesight with high probability. Further, in case highly concentrated methanol splashes under an unassumed high temperature, the methanol may catch fire. Accordingly, it is considered optimal, including the case of the DMFC, to adopt a means to supply the methanol in a liquid supply container made up as a cartridge instead of directly handling the methanol, in order to safely and easily supplying the fuel to general users, and such means is being widely developed (For example, ref. patented documents 1 and 2).
[Patent document 1] JP-A No. 2003-308871
[Patent document 2] JP-A No. H08-12301

### DISCLOSURE OF THE INVENTION

### [Problem to be Solved by the Invention]

The conventional liquid supply containers are normally designed so as to secure certain strength of the liquid chamber and casing, on the assumption of all kinds of temperature conditions during the use and off time, however it is still possible that the internal pressure abnormally increases because the liquid supply container has been left under an unassumed high temperature, thereby abruptly breaking the liquid supply container. In such case, the fragments of the casing, or the liquid stored in the liquid chamber may splash around.

Also, leaving the liquid supply container under an unassumed high temperature may make it inappropriate to continue the use thereof, for example because of degradation in strength of the liquid chamber or alteration of the component of the liquid, though not so serious as the abrupt breakdown due to the abnormal increase in internal pressure. In such case, it is desirable that the user is made aware that the liquid supply container has once undergone the abnormal increase in internal pressure.

The present invention has been accomplished in view of the foregoing situation, with an object to provide a liquid supply container that can be exempted from abrupt breakdown due to the abnormal increase in internal pressure, despite being left under an unassumed high temperature, and a fuel cell system including such liquid supply container.

Another object of the present invention is to provide a liquid supply container that leads the user to recognize that the liquid supply container has once undergone the unassumed high temperature, and a fuel cell system including such liquid supply container.

### [Means for Solving Problem]

According to the present invention, there is provided a liquid supply container comprising a liquid chamber that stores therein a liquid; and a liquid supply port provided in the liquid chamber so as to supply the liquid stored in the liquid chamber to a liquid acceptor; wherein the liquid chamber includes a pressure releaser that allows communication between an inside and an outside of the liquid chamber in the case where internal pressure increases over a predetermined level.

The liquid supply container thus constructed allows communication between the inside and the outside of the liquid chamber before the internal pressure reaches the abnormal level, even though the liquid supply container is left under an unassumed high temperature that may provoke an abnormal increase in internal pressure in the liquid chamber, and thereby releases the increased internal pressure, thus preventing the abrupt breakdown due to the abnormal increase in internal pressure.

In the liquid supply container according to the present invention, the pressure releaser may be constituted of a vulnerable portion, for example a groove, formed on a surface of the liquid chamber.

Under the foregoing structure, as the internal pressure in the liquid chamber increases, a rip is created on the liquid chamber from the vulnerable portion (groove), through which the internal pressure is released. The reference pressure that incurs the rip from the vulnerable portion (groove) may be easily determined and also modified, according to the shape of the vulnerable portion such as the cross-sectional shape (V-shape, U-shape, semicircular, arcuate and so on) and the size (aperture width, aperture area, depth and so on) of the groove.

In the liquid supply container according to the present invention, the liquid supply port may be adhered to the liquid chamber, and the pressure releaser may be constituted of a weaker adhesion portion where the adhesion strength between the liquid chamber and the liquid supply port is made locally weaker than in the remaining portion.

Under the foregoing structure, as the internal pressure in the liquid chamber increases, the sealing effect between the liquid supply port and the liquid chamber at the weaker adhesion portion is degraded or completely lost, so that the internal pressure is released through the weaker adhesion portion. The reference pressure that incurs the degradation or complete loss of the sealing effect may be easily determined and also modified, for example according to a difference in chemical adhesion strength, or, in the case where the chemical adhesion strength is the same, a difference in physical strength (for example, adjusting the adhesion area per unit area).

According to the present invention, there is also provided a liquid supply container comprising a liquid chamber that stores therein a liquid; and a liquid supply port provided in the liquid chamber so as to supply the liquid stored in the liquid chamber to a liquid acceptor; wherein the liquid chamber includes a detector that detects an increase in internal pressure over a predetermined level.

With the liquid supply container thus constructed, in the case where it is inappropriate to continue to use the liquid supply container in which the internal pressure in the liquid chamber once abnormally increased, though not so drastically as causing abrupt breakdown, as a result of being left under an unassumed high temperature, the user can be led to recognize to that effect.

For example, the detector may be constituted of a thermal label with a non-retrospective indicator that changes its color at a predetermined temperature and does not restore the original color once changed. Alternatively, a shape memory alloy or a shape memory resin may be employed to constitute the detector, as an example of memory units to be described later, so as to grant the detector with the characteristic that the shape deformed at a predetermined temperature is retained under room temperature, so that the user can be led to recognize the abnormality from the change in shape of the detector.

The liquid supply container thus constructed leads the user to recognize in advance of use that the liquid supply container has once undergone an unassumed high temperature in view of the color change of the thermal label.

In the liquid supply container according to the present invention, the liquid chamber may be a bag-shaped liquid bag, and the detector may include a redundant portion formed by causing a portion of the liquid bag to project such that an inner surface thereof is brought into mutual contact, a holder that holds the redundant portion, and a removal detector that detects that the holder comes off from the redundant portion. In this case, the holder is configured to serve as a switch, so that an ON or OFF removal detection signal is output to the removal detector according to the holding status (whether holding or removed).

Under the foregoing structure, in case the internal pressure in the liquid chamber abnormally increases, the liquid chamber expands thereby forcing the projection of the redundant portion to disappear so that the holder comes off from the redundant portion, which serves as the trigger for the removal detection signal to be input to the removal detector, and therefore the user can be led to recognize in advance of use that the internal pressure has once abnormally increased in view of the output from the removal detector (for example, a visible alarm display).

The liquid supply container according to the present invention may further comprise a memory unit in which a memory of an incident that the internal pressure has increased over the predetermined level.

The memory unit can be exemplified by an IC chip. Under such structure, the user can read out from the IC chip that the internal pressure has once increased over the predetermined level, to thereby recognize the fact in advance of use.

Also, the memory unit may be formed as at least a part of the liquid supply port, and at least a part of the liquid supply port may be constituted of a material having a shape memory property that restores a shape that can no longer be connected to the liquid acceptor at a temperature over the predetermined level.

Under such structure, if the liquid chamber ever undergoes a temperature over the predetermined level, the liquid supply port of the liquid chamber can no longer be connected to the liquid acceptor for use, and hence the user can be led to recognize in advance of use that the liquid supply container has once undergone an unassumed high temperature, and can prevent the use, whether intentional or unintentional, of the liquid supply container which may break from continuous use.

In the liquid supply container according to the present invention, the liquid chamber may include a liquid bag that stores a liquid therein, and a casing that encloses the liquid bag therein such that a predetermined gap is secured between the casing and the liquid bag located therein even when the liquid bag is completely filled with the liquid, and the pressure releaser may be constituted of a piercer capable of piercing the liquid bag, provided on an inner wall of the casing opposing the gap.

In the liquid supply container thus constructed, even though it is left under an unassumed high temperature that may provoke an abnormal increase in internal pressure in the liquid bag, the liquid bag expands thereby pressing the piercer so that a hole is opened, and thus releasing the increased internal pressure through the hole before the internal pressure reaches the abnormal level, and abrupt breakdown due to the abnormal increase in internal pressure can be prevented.

Besides, since the liquid bag is enclosed by the casing, the liquid that has leaked out of the liquid bag is inhibited from flowing out of the casing.

In the liquid supply container according to the present invention, the liquid may be a liquid fuel for use in a fuel cell.

According to the present invention, there is provided a fuel cell system comprising a fuel cell, the liquid supply container according to the present invention, a liquid fuel stored in the liquid supply container, and a liquid acceptor that accepts the liquid fuel supplied by the liquid supply container, so as to generate power from the liquid fuel supplied to the liquid acceptor.

The fuel cell system thus constructed allows communication between the inside and the outside of the liquid chamber before the internal pressure reaches the abnormal level, even though the liquid supply container is left under an unassumed high temperature that may provoke an abnormal increase in internal pressure in the liquid chamber, and thereby releases the increased internal pressure, thus preventing the abrupt breakdown due to the abnormal increase in internal pressure.

Also, in the case where it is inappropriate to continue to use the liquid supply container in which the internal pressure in the liquid chamber once abnormally increased, though not so drastically as causing abrupt breakdown, as a result of being left under an unassumed high temperature, the user can be led to recognize to that effect.

### [Advantage of the Invention]

The liquid supply container according to the present invention allows communication between the inside and the outside of the liquid chamber before the internal pressure reaches the abnormal level, even though the liquid supply container is left under an unassumed high temperature that may provoke an abnormal increase in internal pressure in the liquid chamber, and thereby releases the increased internal pressure, thus preventing the abrupt breakdown due to the abnormal increase in internal pressure. The liquid supply container prevents, therefore, the liquid in the liquid chamber and fragments of the casing enclosing the liquid chamber from splashing around, despite being left under unassumed high temperature.

Also, in the liquid supply container according to the present invention, a liquid fuel for use in a fuel cell may be stored in the liquid chamber.

Further, with the liquid supply container according to the present invention, in the case where it is inappropriate to continue to use the liquid supply container in which the internal pressure in the liquid chamber once abnormally increased, though not so drastically as thereby causing abrupt breakdown, the user can be led to recognize to that effect. Accordingly, refraining from using (replacing with a new one) the liquid supply container once left unassumed high temperature allows preventing the liquid in the liquid chamber and fragments of the casing enclosing the liquid chamber from splashing around. Moreover, the use of the liquid supply container under an inappropriate condition can be prevented, such as with the strength of the liquid chamber degraded (which often permits the liquid to leak, though not so serious as splashing of the liquid or fragments), and with the component of the liquid in the liquid chamber altered.

Still further, the fuel cell system according to the present invention allows communication between the inside and the outside of the liquid chamber before the internal pressure reaches the abnormal level, even though the liquid supply container is left under an unassumed high temperature that may provoke an abnormal increase in internal pressure in the liquid chamber, and thereby releases the increased internal pressure, thus preventing the abrupt breakdown due to the abnormal increase in internal pressure, which further allows preventing the liquid in the liquid chamber and fragments of the casing enclosing the liquid chamber from splashing around, even though the liquid supply container is left under an unassumed high temperature.

Still further, since the fuel cell system leads the user to recognize that it is inappropriate to continue to use the liquid supply container in which the internal pressure in the liquid chamber once abnormally increased, though not so drastically as thereby causing abrupt breakdown, refraining from using (replacing with a new one) the liquid supply container once left unassumed high temperature leads to prevention of the liquid in the liquid chamber and fragments of the casing enclosing the liquid chamber from splashing around. Moreover, the use of the liquid supply container under an inappropriate condition can be prevented, such as with the strength of the liquid chamber degraded (which often permits the liquid to leak, though not so serious as splashing of the liquid or fragments), and with the component of the liquid in the liquid chamber altered.

### BRIEF DESCRIPTION OF THE DRAWINGS

The above and other objects, features and advantages will become more apparent through the following description of preferred embodiments and the accompanying drawings.

FIG. 1 is a perspective view showing a liquid supply container according to a first embodiment of the present invention;

FIG. 2 is a side view of the liquid supply container shown in FIG. 1;

FIG. 3 is a cross-sectional view taken along a line III-III in FIG. 1;

FIG. 4 is an enlarged cross-sectional view taken along a line IV-IV in FIG. 2, and shows a portion around a liquid supply port of the liquid supply container;

FIG. 5 is a plan view from inside of the liquid chamber, showing the liquid supply port of FIG. 4;

FIG. 6 is a schematic diagram of a fuel cell system including the liquid supply container according to the first embodiment of the present invention;

FIG. 7 is a plan view from inside of the liquid chamber, showing a liquid supply port of the liquid supply container according to another embodiment of the present invention;

FIG. 8 is an enlarged cross-sectional view showing a portion of the liquid supply container and a periphery of that portion, according to still another embodiment of the present invention; and

FIG. 9 is an enlarged cross-sectional view showing a portion of the liquid supply container and a periphery of that portion, according to still another embodiment of the present invention.

### BEST MODE FOR CARRYING OUT THE INVENTION

Hereunder, a liquid supply container according to preferred embodiments of the present invention, as well as a fuel cell system including such liquid supply container will be described referring to the drawings. It is to be understood that the following embodiments are merely exemplary and not for limiting the present invention thereto, and that the present invention may be embodied in various different manners, within the scope thereof.

### First Embodiment

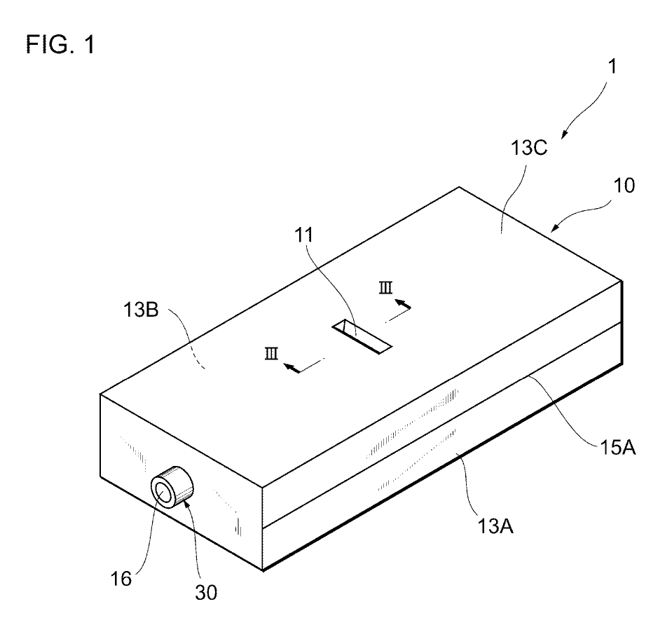

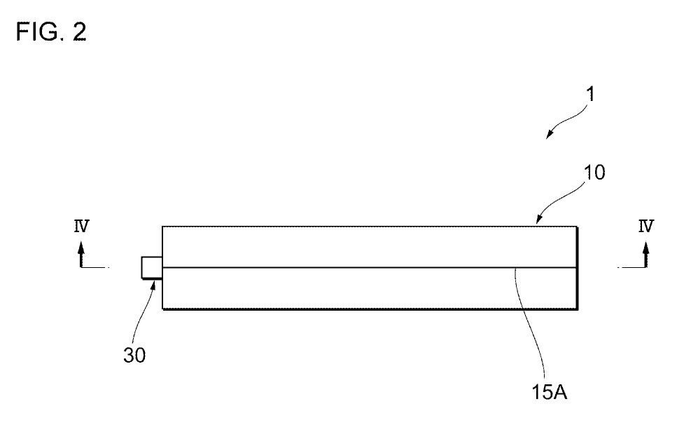

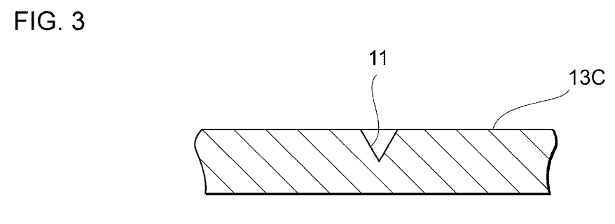

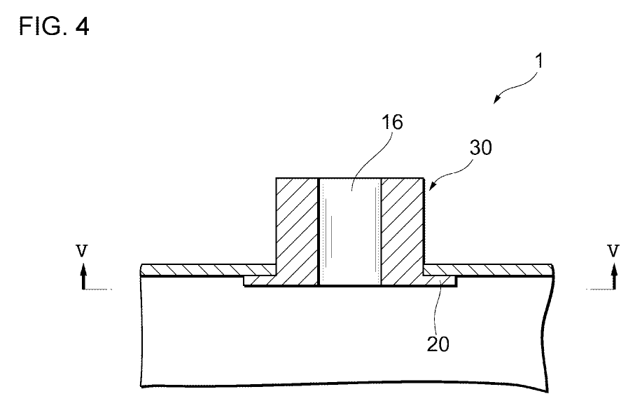

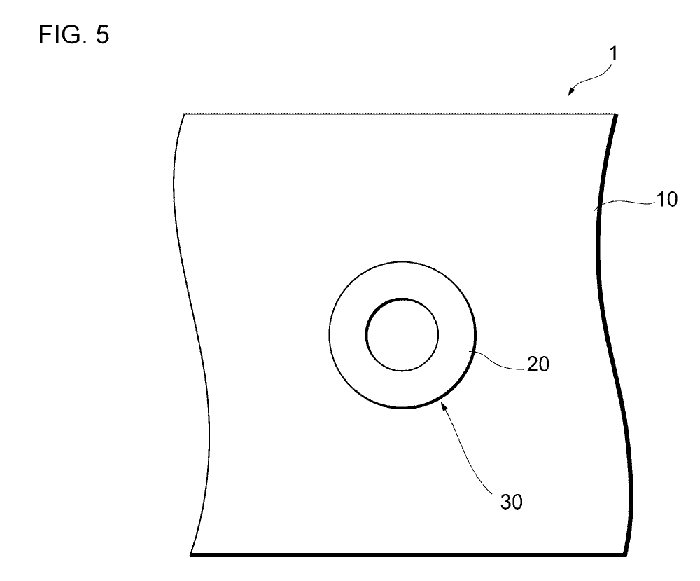

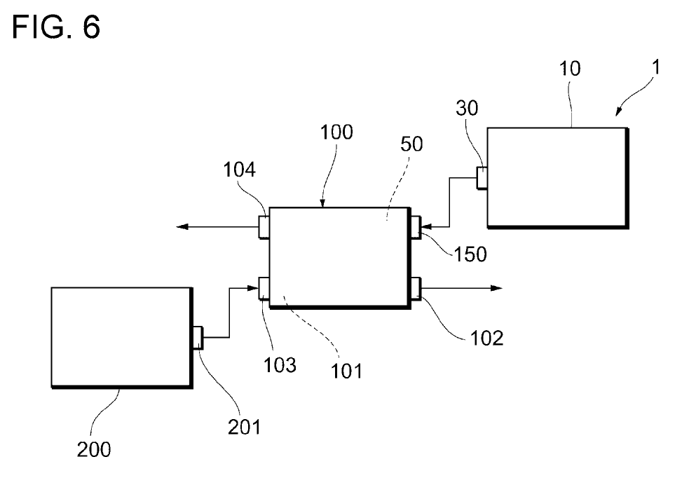

FIG. 1 is a perspective view showing the liquid supply container according to a first embodiment of the present invention; FIG. 2 is a side view of the liquid supply container shown in FIG. 1; FIG. 3 is a cross-sectional view taken along a line III-III in FIG. 1; FIG. 4 is an enlarged cross-sectional view taken along a line IV-IV in FIG. 2, and shows a portion around a liquid supply port of the liquid supply container; FIG. 5 is a plan view from inside of the liquid chamber, showing the liquid supply port of FIG. 4; and FIG. 6 is a schematic diagram of the fuel cell system including the liquid supply container according to the first embodiment of the present invention.

Here, this embodiment represents the case where a liquid fuel for use in a fuel cell is stored in a liquid chamber of the liquid supply container, and the liquid fuel is to be supplied to a liquid acceptor of the fuel cell, as an example.

As shown in FIGS. 1 to 6, the liquid supply container 1 according to this embodiment includes a liquid chamber 10 that stores therein the liquid fuel, and a liquid supply port 30 provided in the liquid chamber 10 so as to supply the liquid fuel stored in the liquid chamber 10 to a liquid acceptor 50 of the fuel cell 100 separately provided.

The liquid chamber 10 is constituted of a bag including a pair of lateral faces 13A and 13B disposed to oppose each other, so as to form a generally rectangular block when completely filled with the liquid fuel, and the pair of lateral faces 13A and 13B has a gusset-fold structure. In other words, the lateral faces 13A and 13B are set to be folded generally in a V-shape inwardly of the liquid chamber 10, such that the gusset-folding lines 15A and 15B each come to the top. The folding line 15B formed on the lateral face 13B is located so as to oppose the folding line 15A, though not shown.

On an upper face 13C of the liquid chamber 10 extending between the lateral faces 13A, 13B, a groove 11 is provided as an example of the pressure releaser or the vulnerable portion that allows communication between the inside and the outside of the liquid chamber 10 in case the internal pressure therein increases over a predetermined level. The groove 11 is formed, as shown in FIG. 1, so as to extend over a predetermined length at a generally central position on the rectangular upper face 13C and along a shorter side thereof, and the cross-sectional shape of the groove 11 is generally V-shaped as shown in FIG. 3.

Here, the groove 11 may be formed at the same time as forming the liquid chamber 10, or by cutting off a portion of the surface of the liquid chamber 10 or performing an embossing process thereon, after forming the liquid chamber 10.

The liquid supply port 30 is provided on a face of the liquid chamber 10 different from the lateral faces 13A and 13B (in this embodiment, on a longitudinal end face). The liquid supply port 30 is, as shown in FIG. 4, of a hollow cylindrical shape with a flange portion 20 on an end portion thereof, and the hollow portion opened along the axial center constitutes a liquid supply path 16 through which the liquid fuel stored in the liquid chamber 10 is to be supplied to the liquid acceptor 50.

The liquid supply port 30 is configured, though not shown, such that the liquid supply path 16 is opened upon being connected to the liquid acceptor 50, so as to prevent the liquid fuel stored in the liquid chamber 10 from accidentally leaking out.

The flange portion 20 is exposed in the liquid chamber 10 as shown in FIGS. 4 and 5, and formed so as to radially extend inside the liquid chamber 10 along the face on which the liquid supply port 30 is provided. The liquid supply port 30 and the liquid chamber 10 are fixed to each other by, for example, thermally pressing the flange portion 20 and the inner surface of the liquid chamber 10. Here, the flange portion 20 and the liquid chamber 10 may be fixed with an adhesive.

In the liquid supply container 1 thus constructed, even though it is left under an unassumed high temperature, a rip is formed on the upper face 13C of the liquid chamber 10 starting from the groove 11 because of an increase in internal pressure in the liquid chamber 10, before the increase reaches an abnormal level, so that the internal pressure is released through the ripped portion. In other words, the inside and outside of the liquid chamber 10 communicate with each other thereby releasing the increased internal pressure, thus preventing abrupt breakdown due to the abnormal increase in internal pressure, and also preventing the liquid in the liquid chamber 10 from splashing around.

The reference pressure that incurs the rip from the groove 11 may be easily determined and also modified, according to the shape of the groove 11 such as the cross-sectional shape (V-shape, U-shape, semicircular, arcuate and so on) and the size (aperture width, aperture area, depth and so on) thereof.

Referring now to FIG. 6, the case of applying the liquid supply container according to this embodiment to the fuel cell system will be described.

The fuel cell system according to this embodiment 1 includes a fuel cell 100, a liquid supply container 1 connected to an inlet 150 of a liquid acceptor 50 that supplies a fuel (liquid fuel in this embodiment) to the anode of the fuel cell 100, and an oxygen gas source 200 connected to an inlet 103 of an air supply port 101 through which oxygen gas (normally air) is supplied to the cathode of the fuel cell 100.

The numeral 102 designates an off-gas discharge port through which the off-gas from the anode of the fuel cell 100 is discharged outside; 104 an off-gas discharge port through which the off-gas from the cathode of the fuel cell 100 is discharged outside; and 201 an oxygen gas supply port of the oxygen gas source 200.

Although the liquid supply port 30 of the liquid supply container 1 and the inlet 150 of the liquid acceptor 50 are connected via an arrow in FIG. 6 for convenience sake, the liquid supply port 30 and the inlet 150 may be connected directly, or via a connector such as a piping or a tube. This also applies to the oxygen gas supply port 201 and the oxygen gas inlet 103. The oxygen gas source 200 may be, for example, a storage container such as a tank containing the oxygen gas, but alternatively air may be directly taken in from the atmosphere.

Various types of fuel cells may be employed as the fuel cell 100, out of which the DMFC is employed in this embodiment, and methanol is contained (stored) in the liquid chamber 10 of the liquid supply container 1.

When generating power with the fuel cell system thus arranged, the liquid fuel stored in the liquid chamber 10 of the liquid supply container 1 is supplied to the liquid acceptor 50 through the liquid supply port 30. The liquid fuel is supplied from the liquid chamber 10 to the liquid acceptor 50 normally by suction with a pump or the like provided in the fuel cell system. The fuel cell 100 causes the hydrogen ion extracted from the liquid fuel supplied to the liquid acceptor 50 and the oxygen supplied from the oxygen gas source 200 (or air directly taken in from the atmosphere) to electrochemically react, thereby generating power.

In the fuel cell system thus constructed, even though it is left under an unassumed high temperature with the liquid supply container 1 connected to the liquid acceptor 50, a rip is formed on the upper face 13C of the liquid chamber 10 starting from the groove 11 so as to allow communication between the inside and the outside, before the increase reaches an abnormal level, so that the internal pressure is released through the ripped portion, thus preventing abrupt breakdown due to the abnormal increase in internal pressure, and also preventing the liquid in the liquid chamber 10 from splashing around.

Although in this embodiment the liquid chamber 10 is constituted of a bag that forms a generally rectangular block when completely filled with the liquid fuel, which is folded as the liquid fuel is consumed, the liquid chamber 10 may be of a different shape without limitation thereto, as long as the liquid can be stored therein and the shape is deformable according to the quantity stored therein.

Also, the groove 11 may be located at a desired position on the upper face 13C of the liquid chamber 10, or at a desired position on a desired face different from the upper face 13C. Further, although this embodiment represents the case where the liquid fuel for use in the fuel cell 100 is stored in the liquid chamber 10, the liquid to be stored in the liquid chamber 10 may naturally be selected as desired, without limitation to the above.

### Second Embodiment

A liquid supply container according to a second embodiment of the present invention will now be described, referring to the drawings. In the second embodiment, the same constituents as those of the first embodiment will be given the same numeral, and detailed description thereof will not be repeated.

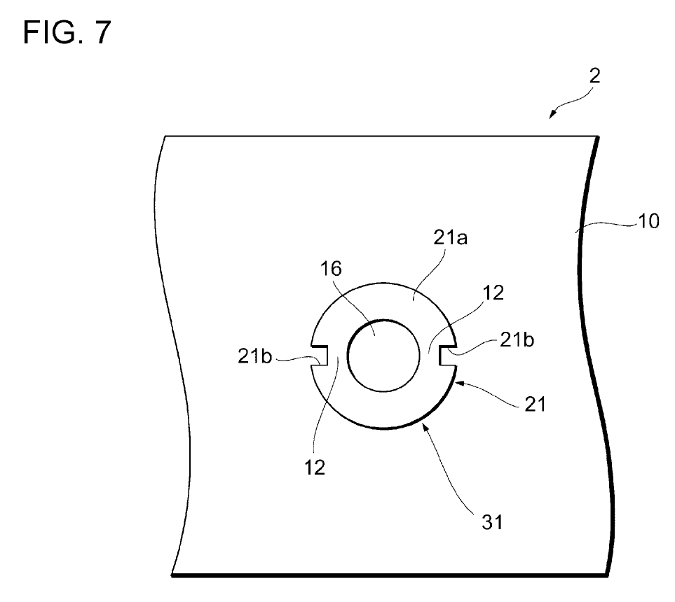

FIG. 7 is a plan view from inside of the liquid chamber 10, showing a liquid supply port 31 of the liquid supply container 2 according to the second embodiment. As shown therein, a major difference between the liquid supply container 2 according to this embodiment and the liquid supply container 1 of the foregoing embodiment lies in the shape of the flange portion 21 of the liquid supply port 31.

An end portion of the liquid supply port 31, more specifically a flange portion 21 provided on the end portion on the side of the liquid chamber 10, includes cutaway portions 21b formed on a ring-shaped flange body 21a. Accordingly, the adhesion strength between the flange portion 21 of the liquid supply port 31 and the liquid chamber 10 is weaker at the region between each cutaway portion 21b and the liquid supply path 16, than in the remaining region.

Thus, the region of the flange portion 21 between the cutaway portion 21b and the liquid supply path 16 acts as a weaker adhesion portion 12, which is an example of the pressure releaser that allows communication between the inside and the outside of the liquid chamber 10 in case the internal pressure in the liquid chamber 10 exceeds the predetermined level. The cutaway portions 21b defining the weaker adhesion portion 12 are of a rectangular shape with an opening on the side of the outer circumference of the flange body 21a, and formed in a pair at an interval of 180 degrees circumferentially of the flange body 21a. However, the shape and the number of cutaway portions 21b may be otherwise determined as desired.

In the liquid supply container 2 thus constructed, the sealing effect of the region between the flange portion 21 of the liquid supply port 31 and the liquid chamber 10 corresponding to the weaker adhesion portion 12 is degraded or completely lost, as the internal pressure in the liquid chamber 10 increases. Accordingly, the liquid supply container 2 allows, despite being left under an unassumed high temperature, releasing the internal pressure through the weaker adhesion portion 12 before the internal pressure in the liquid chamber 10 reaches the abnormal level, thereby preventing abrupt breakdown due to the abnormal increase in internal pressure, and thus preventing the liquid in the liquid chamber 10 from splashing around.

Also, the liquid supply container 2 may be applied to a fuel cell system like the liquid supply container 1, and can offer the same advantages.

Here, the reference pressure that incurs the degradation or complete loss of the sealing effect of the weaker adhesion portion 12 may be easily determined and also modified, for example according to a difference in chemical adhesion strength, or, in the case where the chemical adhesion strength is the same, a difference in physical strength (for example, adjusting the adhesion area per unit area as in this embodiment).

### Third Embodiment

A liquid supply container according to a third embodiment of the present invention will now be described, referring to the drawings. In the third embodiment, the same constituents as those of the first embodiment will be given the same numeral, and detailed description thereof will not be repeated.

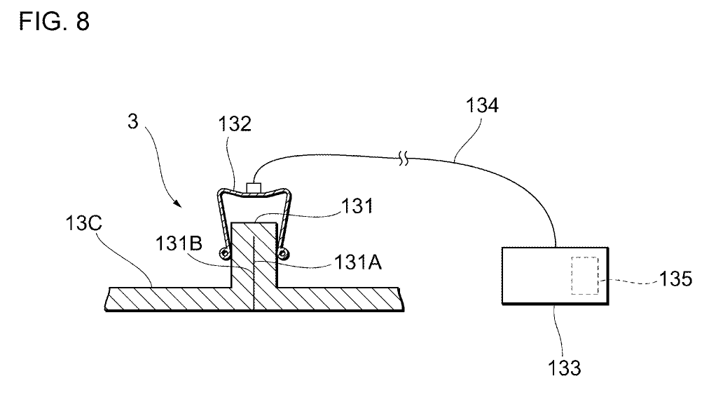

FIG. 8 is an enlarged cross-sectional view showing a portion of the liquid supply container 3 and a periphery of that portion, according to the third embodiment. As shown therein, a major difference between the liquid supply container 3 according to this embodiment and the liquid supply container 1 of the foregoing embodiment lies in that a redundant portion 131 is provided on a face (for example, upper face 13C) of the liquid chamber 10 instead of the groove 11, and that a holder 132 that holds the redundant portion 131 and a removal detector 133 are provided, so as to detect that the holder 132 has come off from the redundant portion 131.

The redundant portion 131 is formed by causing a portion of the upper face 13C of the liquid chamber 10 to project such that inner faces 131A and 131B are brought into mutual contact, so that, for example, the inner faces 131A and 131B in mutual contact are separated from each other when the internal pressure in the liquid chamber 10 increases thereby applying tensile stress to the upper face 13C in the plane direction, until the projecting portion i.e. the redundant portion 131 disappears, thus increasing the volume of the liquid chamber 10 in comparison with the initial volume before the increase in internal pressure.

The holder 132 serves to seize, for example like a clip, an object with a predetermined seizing force. The predetermined seizing force may be defined as a force that permits the holder to keep seizing the redundant portion 131 without coming off therefrom, against the force that urges the inner faces 131A and 131B to move away from each other, in other words against the tensile stress exerted in the plane direction of the upper face 13C, as long as the internal pressure in the liquid chamber 10 is below the predetermined level.

The holder 132 and the removal detector 133 that detects the removal of the holder 132 from the redundant portion 131 are connected via a signal line 134, so that the removal of the holder 132 from the redundant portion 131 serves as the trigger, in other words a kind of switch, so as to input an ON or OFF removal detection signal to the removal detector 133, according to the holding status (whether holding or removed).

The removal detector 133 outputs, upon receipt of the removal detection signal, for example a visible alarm display that alerts the user that the internal pressure in the liquid chamber 10 has increased over the predetermined level. Thus, the removal detector 133 works as a detector that permits recognizing that the liquid chamber 10 has once undergone an increase in internal pressure over the predetermined level.

In the liquid supply container 3 thus constructed, in case the internal pressure in the liquid chamber 10 abnormally increases, the liquid chamber 10 expands thereby forcing the projection of the redundant portion 131 to disappear so that the holder 132 comes off from the redundant portion 131, which serves as the trigger for the removal detection signal to be input to the removal detector 133, and therefore the user can be led to recognize in advance of use that the internal pressure has once abnormally increased in view of the output from the removal detector 133.

Therefore, in the case where it is inappropriate to continue to use the liquid supply container 3 in which the internal pressure in the liquid chamber 10 once abnormally increased, though not so drastically as causing abrupt breakdown, as a result of being left under an unassumed high temperature, the user can be led to recognize to that effect, and can hence properly replace the liquid supply container 3 which is likely to break, with a new one.

Here, the removal detector 133 may include a built-in IC chip (memory unit) 135 (indicated by broken lines in FIG. 8) so as to store therein the memory that the liquid chamber 10 has undergone the increase in internal pressure over the predetermined level, in addition to or instead of visibly outputting the alarm display to that effect.

Alternatively, as another embodiment of the memory unit that memorizes that fact that the liquid chamber 10 has undergone the increase in internal pressure over the predetermined level, at least a portion of the liquid supply port 30 may be constituted of a material having a shape memory property, such as a shape memory alloy or a shape memory resin, that maintains a shape that permits liquid-tight connection with the liquid acceptor 50 at room temperature, but that restores (deforms to) a shape that can no longer be connected to the liquid acceptor 50 at a temperature over the predetermined level.

Under such structure, if the liquid chamber 10 ever undergoes the increase in internal pressure over the predetermined level, the liquid supply port 30 of the liquid chamber 10 can no longer be connected to the liquid acceptor 50 for use, and hence the user can be led to recognize in advance of use that the liquid chamber 10 has once undergone the abnormal increase in internal pressure, and can prevent the use, whether intentional or unintentional, of the liquid supply container 3 which may break from continuous use, as well as the splashing of the liquid in the liquid chamber 10.

Further, examples of the detector capable of detecting that the liquid chamber 10 has once undergone the increase in internal pressure over the predetermined level include, in addition to the embodiment shown in FIG. 8, a thermal label with a non-retrospective indicator that changes its color at a predetermined temperature and does not restore the original color once changed. In this case, the user can be led to recognize in advance of use that the internal pressure once increased abnormally, in view of the color change of the thermal label. The thermal label may be attached to the surface of the liquid chamber 10 or, in the case where the liquid chamber 10 is enclosed in the casing, to the surface of the casing. Further, the thermal label may be designed so as to display letters such as “DON'T USE”, or a symbol or mark that alerts the user to the prohibition of use.

Also, the liquid supply container 3 may be applied to a fuel cell system like the liquid supply container 1, and can offer the same advantages.

### Fourth Embodiment

A liquid supply container according to a fourth embodiment of the present invention will now be described, referring to the drawings. In the fourth embodiment, the same constituents as those of the first embodiment will be given the same numeral, and detailed description thereof will not be repeated.

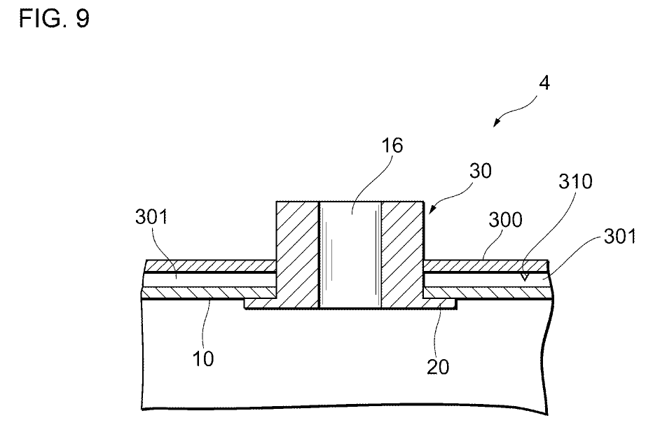

FIG. 9 is an enlarged cross-sectional view showing a portion of the liquid supply container and a periphery of that portion, according to the fourth embodiment. As shown therein, a major difference between the liquid supply container 4 according to this embodiment and the liquid supply container 1 of the foregoing embodiment lies in that outside the liquid chamber 10 a casing 300 is provided, so as to enclose therein the liquid chamber 10.

The casing 300 is constituted of a material such as a PPS resin which is stronger than the liquid chamber 10 formed of a laminated film or a PE resin so as to store therein the liquid, and is formed in predetermined shape and dimensions so as to secure a predetermined gap 301 between the casing 300 and the liquid chamber 10 enclosed therein, even when the liquid chamber 10 is completely filled with the liquid. At a predetermined position on the inner wall of the casing 300 opposing the liquid chamber 10 across the gap 301, a sharp projection 310 is integrally or separately provided on the casing 300, as a piercer capable of piercing the liquid chamber 10.

In the liquid supply container 4 thus constructed, even though it is left under an unassumed high temperature, the liquid chamber 10 expands thereby pressing the piercer so that a hole is opened, and thus releasing the increased internal pressure in the liquid chamber 10 through the hole before the internal pressure reaches the abnormal level, thereby preventing abrupt breakdown due to the abnormal increase in internal pressure and the splashing of the liquid in the liquid chamber 10.

In particular, since the liquid supply container 4 includes the casing 300 covering the liquid chamber 10, the liquid that has leaked out through the hole opened on the liquid chamber 10 is inhibited from flowing out of the liquid supply container 4.

Also, the liquid supply container 4 may be applied to a fuel cell system like the liquid supply container 1, and can offer the same advantages.

This application is based on Japanese patent application No. 2006-202942, filed on Jul. 26, 2006, the content of which is incorporated hereinto by reference.

1. A liquid supply container, comprising:
a liquid chamber that stores therein a liquid; and
a liquid supply port provided in said liquid chamber so as to supply said liquid stored in said liquid chamber to a liquid acceptor;
wherein said liquid chamber includes a pressure releaser that allows communication between an inside and an outside of said liquid chamber in the case where internal pressure increases over a predetermined level.

2. The liquid supply container according to claim 1, wherein said pressure releaser includes a vulnerable portion formed on said liquid chamber.

3. The liquid supply container according to claim 2, wherein said vulnerable portion includes a groove.

4. The liquid supply container according to claim 1,
wherein said liquid supply port is adhered to said liquid chamber, and
said pressure releaser is constituted of a weaker adhesion portion where adhesion strength between said liquid chamber and said liquid supply port is made locally weaker than in the remaining portion.

5. A liquid supply container comprising:
a liquid chamber that stores therein a liquid; and
a liquid supply port provided in said liquid chamber so as to supply said liquid stored in said liquid chamber to a liquid acceptor;
wherein said liquid chamber includes a detector that detects an increase in internal pressure over a predetermined level.

6. The liquid supply container according to claim 5, wherein said detector is constituted of a thermal label with a non-retrospective indicator that changes its color at a predetermined temperature and does not restore an original color once changed.

7. The liquid supply container according to claim 5,
wherein said liquid chamber includes a bag-shaped liquid bag; and
said detector includes a redundant portion formed by causing a portion of said liquid bag to project such that an inner surface thereof is brought into mutual contact, a holder that holds said redundant portion, and a removal detector that detects that said holder comes off from said redundant portion.

8. The liquid supply container according to claim 5, further comprising a memory unit that memorizes an incident that said internal pressure has increased over said predetermined level.

9. The liquid supply container according to claim 8, wherein said memory unit includes an IC chip.

10. The liquid supply container according to claim 8, wherein said memory unit is at least a part of said liquid supply port, and is constituted of a material having a shape memory property that restores a shape that can no longer be connected to said liquid acceptor at a temperature over said predetermined level.

11. The liquid supply container according to claim 1,
wherein said liquid chamber includes a liquid bag that stores a liquid therein, and a casing that encloses said liquid bag therein such that a predetermined gap is secured between said casing and said liquid bag located therein even when said liquid bag is completely filled with said liquid, and
said pressure releaser may be constituted of a piercer capable of piercing said liquid bag, provided on an inner wall of said casing opposing said gap.

12. The liquid supply container according to claim 1, wherein said liquid is a liquid fuel for use in a fuel cell.

13. A fuel cell system comprising:
a fuel cell,
said liquid supply container according to claim 1,
a liquid fuel stored in said liquid supply container, and
a liquid acceptor that accepts said liquid fuel supplied by said liquid supply container, so as to generate power from said liquid fuel supplied to said liquid acceptor.
